(19) United States
(12) Patent Application Publication
(10) Pub. No.: US 2007/0164101 A1
(43) Pub. Date: Jul. 19, 2007

(54) Rewritable card printer

(75) Inventor: Eric Meyerhofer, Pasadena, CA (US)

Correspondence Address: FITZPATRICK CELLA HARPER & SCINTO, 30 ROCKEFELLER PLAZA, NEW YORK, NY, 10112, US

(73) Assignee: FUTURELOGIC, INC., Glendale, CA (US)

(21) Appl. No.: 11/332,508

(22) Filed: Jan. 13, 2006

(51) Int. Cl. G06K 5/00; G06F 15/12; G06K 7/00

(52) U.S. Cl. 235/380; 235/432; 235/439

(57) ABSTRACT

A rewritable card printer useful as a rewritable card printer. The rewritable card printer includes a print module coupled to one or more separate card magazines, each having independent card drives. The operation of the print module and one or more card magazines are controlled by a printer controller. Cards may be exchanged between multiple card magazines so that cards can be escrowed, exchanged, or selectively located and retrieved. By manipulating cards within the card magazines, the rewritable card printer may perform various maintenance functions on itself and cards within a card magazine.

### CROSS-REFERENCE TO RELATED APPLICATION

This application is related to U.S. application Ser. No. 10/654,521, filed Sep. 2, 2003, now allowed, U.S. application Ser. No. 10/827,802, filed Apr. 19, 2004, U.S. application Ser. No. 11/258,063, filed Oct. 26, 2005, U.S. patent application Ser. No. 10/640,495 filed Aug. 12, 2003, U.S. patent application Ser. No. 10/618,811 filed Jul. 9, 2003, and U.S. patent application Ser. No. 10/136,897, filed Apr. 30, 2002, the contents of each of which are hereby incorporated by reference as if stated herein in full.

### BACKGROUND OF THE INVENTION

This invention relates generally to gaming printers and more specifically to printers for use in cashless gaming machines that use rewritable cards.

The gaming machine manufacturing industry provides a variety of gaming machines for the amusement of gaming machine players. An exemplary gaming machine is a slot machine. A slot machine is an electro-mechanical game wherein chance or the skill of a player determines the outcome of the game. Slot machines are usually found in casinos or other more informal gaming establishments.

Gaming machine manufacturers have more recently introduced cashless enabled games to the market and these have begun to find wide acceptance in the gaming industry. Cashless enabled games are so named because they can conduct financial exchanges using a mixture of traditional currencies and rewritable cards. Typically, a cashless enabled game has a gaming printer to produce rewritable cards and a rewritable card reader that supports automatic reading of rewritable cards. To coordinate the activities of multiple cashless enabled games, one or more cashless enabled games may be electronically coupled to a cashless enabled game system that controls the cashless operations of a cashless enabled game.

When a player cashes out using a cashless enabled game coupled to a cashless enabled game system, the cashless enabled game signals the system and the system may determine the type of pay out presented to the player. Depending on the size of the pay out, the cashless enabled game system may cause the cashless enabled game to present coins in the traditional method of a slot machine, or the cashless enabled game system may cause a gaming printer in the cashless enabled game to produce a rewritable card for the value of the pay out. The rewritable card may then be redeemed in a variety of ways. For example, the rewritable card may be redeemed for cash at a cashier's cage or used with another cashless enabled game. In order to use the rewritable card in a cashless enabled game, the rewritable card is inserted into a rewritable card reader of another cashless enabled game at a participating casino and the cashless enabled game system recognizes the rewritable card, redeems the rewritable card, and places an appropriate amount of playing credits on the cashless enabled game.

Cashless enabled games have found an increasing acceptance and use in the gaming industry, both with players who enjoy the speed of play and ease of transporting their winnings around the casino and casinos who have realized significant labor savings in the form of reduced coin hopper reloads in the games, and an increase in revenue because of the speed of play. Practical field experience with printers used in cashless enabled games has illustrated that there are areas for improvement in the current printer designs and implementation. These areas in need of improvement include methods and means for using rewritable card media for printing of vouchers.

### SUMMARY OF THE INVENTION

A rewritable card printer useful as a gaming machine printer for printing vouchers is provided. The rewritable card printer includes a print module coupled to one or more separate card magazines, each having independent card drives. The operations of the print module and one or more card magazines is controlled by a printer controller. Cards may be exchanged between multiple card magazines so that cards can be escrowed, exchanged, or selectively located and retrieved. The print module may receive as well as dispense cards from and to an external card source so that the card magazines may be replenished without opening up a gaming machine hosting the rewritable card printer. The print module may further include a security device reader that is used to read security features embedded in the cards. The security features may be used to track individual card use and to guard against card duplication and fraud.

In one aspect of the invention, a process is shared between a rewritable card printer and an external card magazine device which allows the card magazine to issue a special head cleaning card, operable on the erase and print heads, into the rewritable card printer. The rewritable card printer would then exercise the card back and forth with the heads deployed, thereby accomplishing cleaning. After this process, the cleaning card would be returned to the external card magazine. In this manner the heads would be cleaned with each new card loading. Signaling of the cleaning card could either be driven by the rewritable card printer or the card magazine device. The card magazine may have a special storage location for cleaning card(s).

In another aspect of the invention, the rewritable card printer is capable of tracking a cleaning card in a waste card magazine, and after a pre-determined time/number of cards, shuffle out the waste cards into a source card magazine until it locates the cleaning card, exercises the cleaning card through the pathway as described above, and then replaces the cleaning card in the waste magazine, followed by the waste cards temporarily placed into the source magazine.

In another aspect of the invention, a bar which is cooled to a temperature lower than the ambient temperature is located after the print head in the device (in the direction of print) which contacts the card and serves to rapidly lower the temperature of the card shortly after it is printed. The bar may be in the form of a roller. The method of cooling may be an electrical Peltier device. A thermistor may be present on the bar/roller to provide feedback to the controlling rewritable card printer in order to allow a consistent cold temperature to be realized.

In another aspect of the invention, a fan, coupled with a cooling device (such as a Peltier device) provides forced cooled air to the card after the point of printing.

In another aspect of the invention, the rewritable card printer optically scans a card, when it is inserted, to determine the optical density of the print on the card. If the density is poor, the rewritable card printer, signals the host that the card is no longer usable, and when signaled, erases the card and places it in a waste card magazine.

In another aspect of the invention, the optical density measurement is memorized for this card and kept in non-volatile memory. When the card is re-printed, the measurement is used to adjust the heating algorithm, both for erasure and recording the indicia. This measurement follows the card within the magazine, and is erased when card is used and issued, or removed from the card loading/unloading external cassette device.

In another aspect of the invention, the rewritable card printer records on a card its amount of erase/print cycles, either in the printed indicia or in the magnetic stripe or smart card. Then, an auxiliary device which interfaces to a card loading/unloading external magazine, empties and reloads the card magazine, and in the process, culls out cards which have exceeded a pre-set amount of cycles. As another function, the auxiliary device reads the cycle count of each card processed by it and calculates the amount of usable life remaining in the cards which it has processed as an average and as a total rewrite cycle count.

In another aspect of the invention, in a process shared between the rewritable card printer and an external card magazine, the rewritable card printer unloads all cards over a certain amount of cycles. This in essence, allows the casino to cull out old cards, on the gaming floor. The card magazine would is programmed with the amount which was desired in order to instruct the rewritable card printer as to the cycle count trigger threshold. The threshold may also be signaled to the rewritable card printer by an external device that communicates with the rewritable card printer.

In another aspect of the invention, the rewritable card printer, coupled to its controlling system host, is instructed to pre-print all information on a card with the exception of the cash-out amount. The card is held in this state until cash-out. At that point, the final authorization to proceed is given, along with the dollar amount, and the rewritable card printer only prints the cash-out amount. Once confirmation that this was complete is given, then the system could record that the authorization code, and the dollar amount are valid for redemption. The rewritable card printer is then instructed to issue the card.

In another aspect of the invention, the rewritable card printer samples the optical density of the card shortly after print, and based on that measurement determines if the card image will develop to an acceptable level within a reasonable amount of time (re-writable cards can take up to 3 minutes to fully develop, kind of like the old Polaroid film). If the anticipated optical density at t+short_time is within an acceptable range, the card is allowed to be issued. If not, the card is erased and placed into a waste bin and a new card is pulled from the supply to be printed. This process may be repeated after a delay to re-check the optical density reading against the benchmark.

### BRIEF DESCRIPTION OF THE DRAWINGS

These and other features, aspects, and advantages of the present invention will become better understood with regard to the following description, appended claims, and accompanying drawings where:

FIG. 1 is a block diagram of a cashless gaming machine and system in accordance with an exemplary embodiment of the present invention;

FIG. 2a is an illustration of a rewritable card in accordance with an exemplary embodiment of the present invention;

FIG. 2b is an illustration of another portion of a rewritable card in accordance with an exemplary embodiment of the present invention;

FIG. 2c is an illustration of another portion of a rewritable card having a static memory in accordance with an exemplary embodiment of the present invention;

FIG. 3 is a block diagram illustrating a security feature employing capacitive inks in accordance with an exemplary embodiment of the present invention;

FIG. 4 is a block diagram of a security feature utilizing an optical signature in accordance with an exemplary embodiment of the present invention;

FIG. 5 is a block diagram of a security feature using randomly deposited radio sensitive fibers embedded in a rewritable card in accordance with an exemplary embodiment of the present invention;

FIG. 6 is a block diagram of the operation of a rewritable card printer in accordance with an exemplary embodiment of the present invention;

FIG. 7a is a block diagram of a rewritable card printer in accordance with an exemplary embodiment of the present invention;

FIG. 7b is an architecture diagram of a rewritable card printer employing components having integral controllers in accordance with an exemplary embodiment of the present invention;

FIG. 8 is an isometric view of a rewritable card printer in accordance with an exemplary embodiment of the present invention;

FIG. 9 is an isometric view of a rewritable card printer with the card magazine opened in accordance with an exemplary embodiment of the present invention;

FIG. 10 is a top plan view of a rewritable card printer in accordance with an exemplary embodiment of the present invention;

FIG. 11a is side elevation view of a rewritable card printer in accordance with an exemplary embodiment of the present invention;

FIG. 11b is side elevation view of a rewritable card charging process in accordance with an exemplary embodiment of the present invention;

FIG. 11c is a side elevation view of a rewritable card printer with a card magazine having two independent magazine card drives in accordance with an exemplary embodiment of the present invention;

FIG. 11d is a side elevation view of a card magazine having a plurality of card storage locations serviced by a single card magazine drive in accordance with an exemplary embodiment of the present invention;

FIG. 11e is side elevation view of a rewritable card printer slidably coupled to a gaming machine in accordance with an exemplary embodiment of the present invention;

FIG. 12 is a process flow diagram of a rewritable card printing process in accordance with an exemplary embodiment of the present invention;

FIG. 13 is a process flow diagram of a card escrowing process used by a rewritable card printer in accordance with an exemplary embodiment of the present invention;

FIG. 14 is a card retrieval process used by a rewritable card printer having companion magazines in accordance with an exemplary embodiment of the present invention;

FIG. 15 is a process flow diagram of a card location process used by a rewritable card printer having multiple card magazines in accordance with an exemplary embodiment of the present invention;

FIG. 16 is a process flow diagram of a card replacement process in accordance with the present invention;

FIG. 17 is a process flow diagram of a programming process using a rewritable card in accordance with an exemplary embodiment of the present invention;

FIG. 18 is a process flow diagram of a card information storage process in accordance with an exemplary embodiment of the present invention;

FIG. 19 is a process flow diagram of a card information retrieval process in accordance with an exemplary embodiment of the present invention;

FIG. 20 is a stored card status printing process in accordance with an exemplary embodiment of the present invention;

FIG. 21 is a process flow diagram of a head cleaning process in accordance with an exemplary embodiment of the present invention;

FIG. 22 is a schematic diagram of a card cooling system in accordance with an exemplary embodiment of the present invention;

FIG. 23 is a process flow diagram of a pre-scan process in accordance with an exemplary embodiment of the present invention;

FIG. 24 is a process flow diagram of using card cycle history when processing cards in accordance with an exemplary embodiment of the present invention;

FIG. 25 is a process flow diagram of a pre-print process in accordance with an exemplary embodiment of the present invention;

FIG. 26 is a process flow diagram of a benchmark scanning process in accordance with an exemplary embodiment of the present invention; and

FIG. 27 is a schematic diagram of a fan-based card cooling system in accordance with an exemplary embodiment of the present invention.

### DETAILED DESCRIPTION

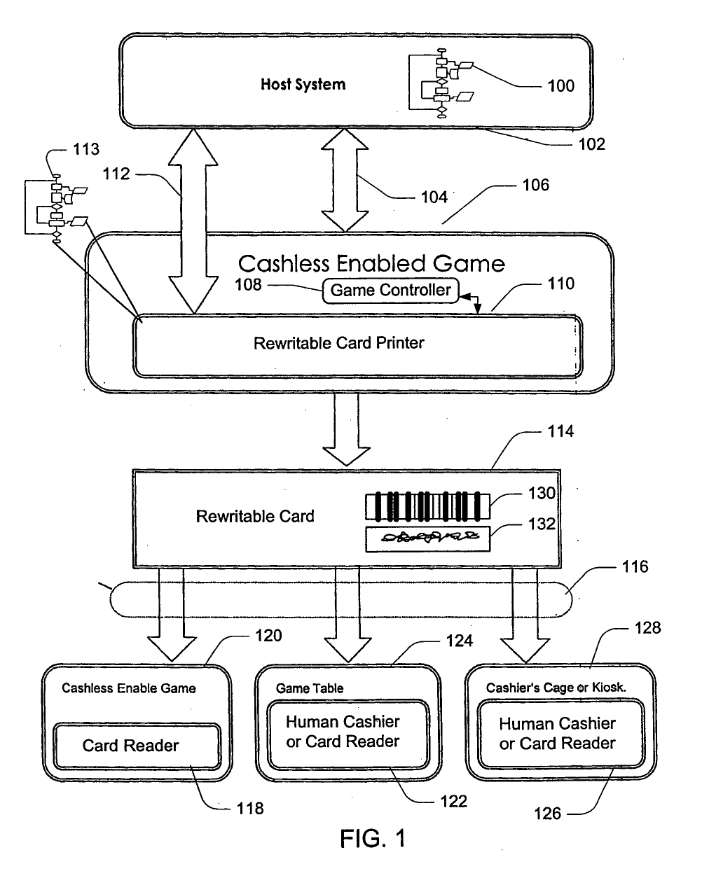

FIG. 1 is a block diagram of a cashless enabled gaming machine coupled to a rewritable card printer in accordance with an exemplary embodiment of the present invention. A cashless gaming system includes a cashless gaming system controller 100 hosted by a system host 102 coupled 104 to one or more cashless enabled games 106. A cashless enabled game includes a game controller 108 that controls the operation of the cashless enabled game. The game controller is coupled to a rewritable card printer 110. The cashless enabled game uses the rewritable card printer to write rewritable card media such as rewritable card 114. The rewritable card printer includes card identification and printing algorithms 113 used in conjunction with rewritable cards. The rewritable card includes the cash-out information for a player.

The rewritable card printer may also be coupled (112) to the host system and cashless gaming controller. The rewritable card may be redeemed (116) in a variety of ways. The rewritable card may be redeemed by a human cashier or card reader 122 at a game table 124, or a human cashier or card reader 126 at a cashier's cage or kiosk 128, or by a card reader 118 at another cashless enabled game 120. Redemption is only possible after the rewritable card passes a verification of account information 130 and validation using security features 132 included in the rewritable card.

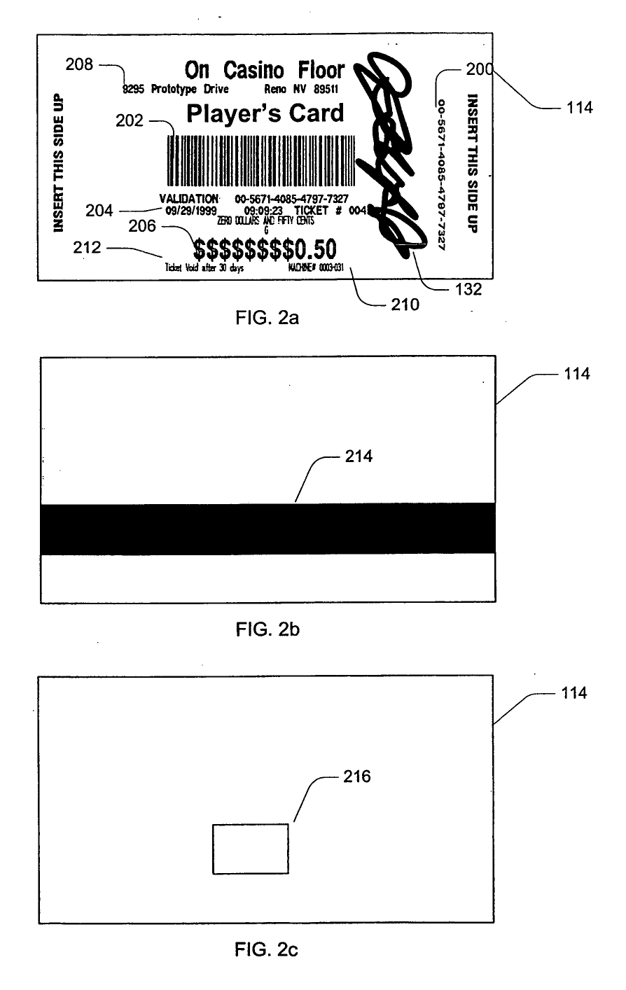

FIG. 2a is an illustration of a rewritable card in accordance with an exemplary embodiment of the present invention. The rewritable card shown is produced from commands issued by the cashless enabled game to the gaming printer in response to a player's request to cash-out. The rewritable card 114 includes features such as a validation number, printed in both a human readable form such as a character string 200 and in a machine-readable form such as a bar code 202, time and date stamps 204, cash-out amount 206, casino location information 208, cashless enabled game identifier 210, and an indication of an expiration date 212. Included in the card is a security feature 132 that may take one or more forms as discussed below.

In one rewriteable card media in accordance with an exemplary embodiment of the present invention, one face of the rewriteable card includes a layer of writable and erasable thermally sensitive film. The thermal film becomes opaque at one temperature level but becomes transparent at another temperature. This effect can be used to create a thermally rewritable card.

FIG. 2b is an illustration of another side of a rewriteable card in accordance with an exemplary embodiment of the present invention. The rewriteable card 114 may also include a read/write magnetic strip 214 for encoding of any of the information described above.

In addition, the magnetic strip may be used to transmit information to the rewritable card printer. For example, the magnetic strip may encode instructions such as configuration flags or programming instructions used to reconfigure or reprogram a rewritable card printer.

FIG. 2c is an illustration of another portion of a rewriteable card having a static memory in accordance with an exemplary embodiment of the present invention. The rewriteable card 114 may also include a static memory 216 embedded in the rewritable card so that the rewritable card can be used as a “smart” card for encoding of any of the information described above.

In addition, the static memory may be used to transmit information to the rewritable card printer. For example, the static memory may encode instructions such as configuration flags or programming instructions used to reconfigure or reprogram a rewritable card printer.

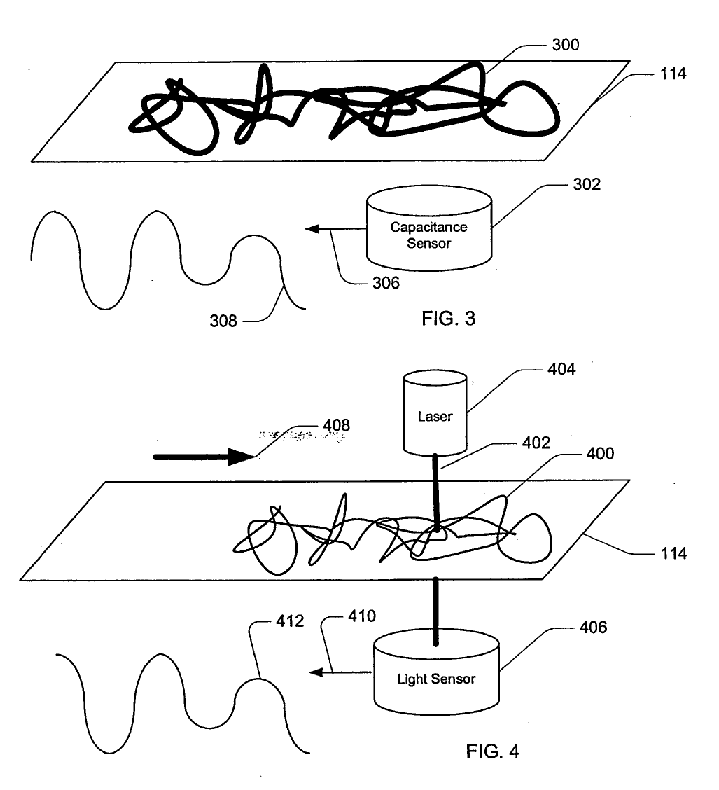

FIG. 3 is a block diagram illustrating a security feature employing capacitive inks in accordance with an exemplary embodiment of the present invention. A rewritable card 114 may be imprinted with metallic inks to create one or more capacitors in the rewriteable card. The one or more capacitors may be used to create a security feature in the form of a capacitor structure 300 whose capacitance may be detected by a capacitance sensor 302 coupled to the rewritable card. As the card moves across the sensor (as indicated by arrow 304) the sensor senses changes in the localized capacitance of the card and generates (306) a security signature signal 308 corresponding to the structure of the capacitor structure 300 in the rewritable card. This security signature signal may be used to identify each rewritable card used in a cashless enabled gaming system.

FIG. 4 is a block diagram of a security feature utilizing an optical signature in accordance with an exemplary embodiment of the present invention. To use this security feature, a rewritable card 114 includes a structure 400 having a variable optical density or optical reflectivity that is not apparent under normal lighting conditions. However, when a high intensity light, such as a laser beam 402 generated by a laser diode 404 or other laser beam generating device, is transmitted through the rewritable card, a light sensor 406 may detect fluctuations in the intensity of the transmitted or reflected laser beam caused by the structure. If the card is moved past the laser beam (as indicated by arrow 408) the moving structure generates a changing light signal that is received by the light sensor. In response to the changing light signal, the light sensor generates (410) a time varying security signature signal 412 that may be used as a signature to uniquely identify each rewritable card used in a cashless gaming system.

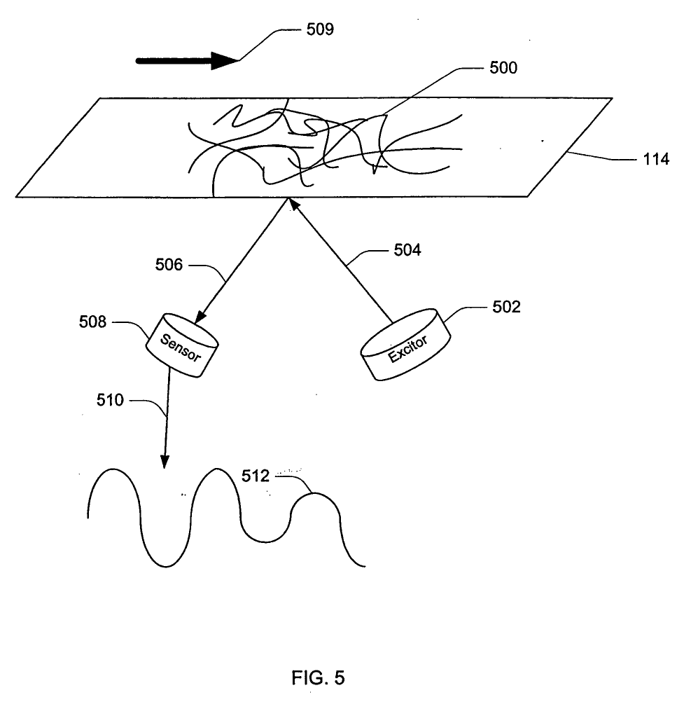

FIG. 5 is a block diagram of a security feature using randomly deposited radio sensitive fibers or inks embedded in a rewritable card in accordance with an exemplary embodiment of the present invention. A rewritable card 114 may include a layer of randomly deposited radio sensitive fibers 500 embedded within the card. An excitor 502 is used to transmit short pulses of radio waves 504 into the layer of fibers. In response to the radio waves, the fibers generate a resultant radio frequency signal 506 that may be detected by a sensor 508. If the rewritable card is moving (as indicated by direction arrow 509) as the fibers are being excited, the sensor receives a time varying radio frequency signal generated by the excited and moving fibers. In response to the time varying radio frequency signal, the sensor generates (510) a time varying security signature signal 512 that may be used to uniquely identify each rewritable card in a cashless gaming system.

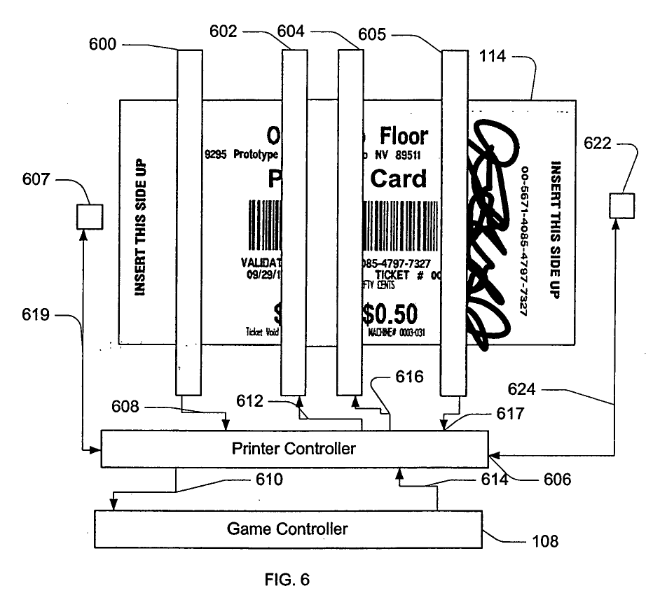

FIG. 6 is a block diagram of the operation of a rewritable card printer in accordance with an exemplary embodiment of the present invention. A rewritable card printer includes a security feature reader 600 for reading a security feature embedded in a rewritable card 114. The type of security feature reader is dependent on the type of security features used with the rewritable card. The security feature reader supplies the appropriate excitation energy and sensor to generate a security signature signal as previously described.

The rewritable card printer also includes an erase head 602 for erasing a rewritable card prior to printing on the rewritable card. The erase head raises the temperature of the rewritable thermal film to the erasing temperature and any images previously written to the rewritable card are erased.

The rewritable card printer also includes a print head 604 for printing on the rewritable card. The print head raises the temperature of the thermal film on the rewritable card to the writing temperature and indicia are printed onto the rewritable card as a result.

The rewritable card printer also includes an optical scanning device 605 for reading the printed indicia on the rewritable card. The operation of such a device is more fully detailed in U.S. patent application Ser. No. 10/136,897, filed Apr. 30, 2002, the contents of which are hereby incorporated by reference as if stated herein in full.

The rewritable card printer also includes a magnetic strip read/write head 607 for reading from, and writing to a magnetic strip 214 (of FIG. 2) on the rewritable card.

The rewritable card printer includes a printer controller 606 operably coupled to the security feature reader. The security feature reader generates a security signature signal 608 that is transmitted to the printer controller.

The printer controller is also coupled to the erase head. The printer controller generates an erase control signal 612 that is transmitted to the erase head. In response to the erase head signal, the erase head heats the rewritable card until all indicia are erased from the rewritable card.

The printer controller is also coupled to the print head. The printer controller transmits print head control signals 616 to the print head. In response to the print head control signals, the print head heats a thermal element for each dot that is to be imaged on the rewritable card. The print head typically creates dot images to a granularity of 12 dots per millimeter, each dot image using a separate thermal element to create a dot image.

The printer controller is also coupled to the optical scanner 605. As the optical scanner scans the printed indicia on the rewritable card, the optical scanner transmits scanned signals 617 to the printer controller.

The printer controller is also coupled to the magnetic strip read/write head 607. The printer controller transmits magnetic strip write signals and receives magnetic strip read signals to and from (619) the magnetic strip read/write head.

The printer controller may also be coupled to a static memory read/write connector 622. The printer controller transmits static memory write signals and receives static memory read signals to and from (624) the static memory read/write head.

The rewritable card printer may also include an optional thermal write head and optional read head (not shown) operably coupled to the printer controller. The optional heads are used to write to and read from write-once media such as thermal paper used for vouchers or coupons. This enables the rewritable card printer to be used in establishments that use both rewritable cards and non-rewritable vouchers and coupons.

In one embodiment of a rewritable card printer in accordance with the present invention, a game controller 108 is operably coupled to the printer controller. The printer controller receives printer control instructions 614, including card information for writing to the rewritable card, from the game controller. The printer controller may also transmit printer status and card identification signals 610 to the game controller.

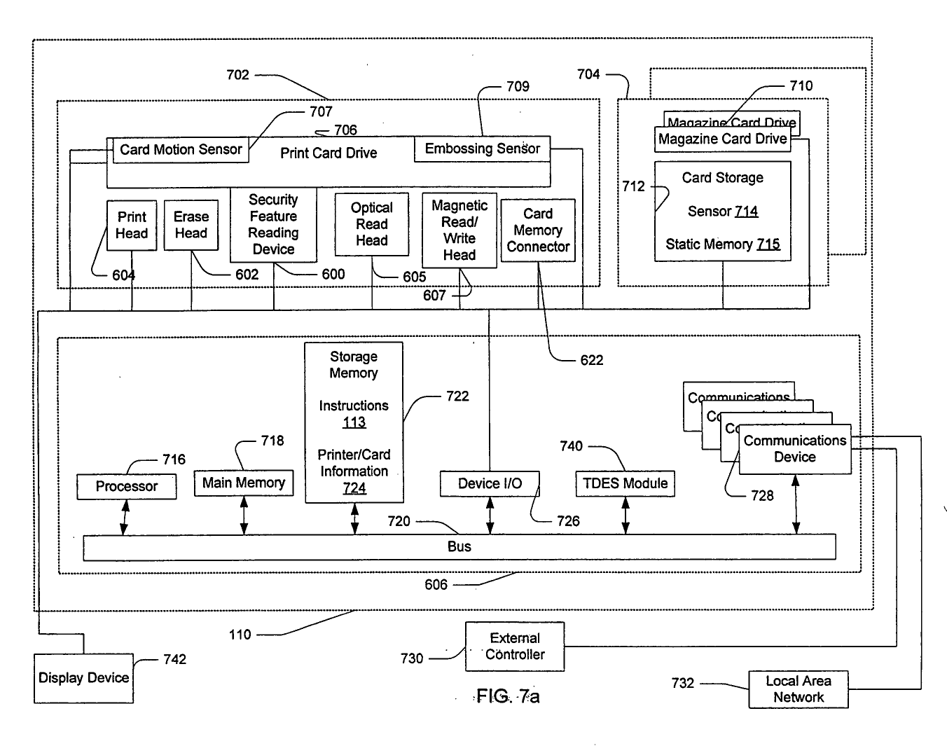

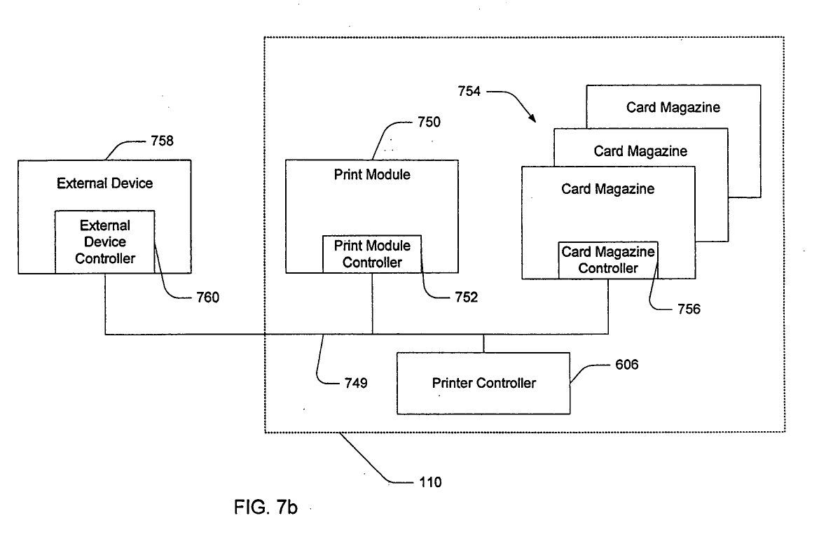

FIG. 7a is a block diagram of a rewritable card printer in accordance with an exemplary embodiment of the present invention. A rewritable card printer 110 includes a printer controller 606, a print module 702, and one or more card magazines 704.

The print module includes a print card drive 706 that moves cards through the print module. The print card drive is reversible such that a card may be fed through the print module in more than one direction by the print card drive. The print card drive includes a card motion sensor 707 for sensing card movement within the print card drive. A more detailed discussion of printer media motion detection within a printer is presented in U.S. patent application entitled “PAPER MOTION DETECTOR IN A GAMING MACHINE”, attorney docket number 50820/FLC/F392 filed Aug. 12, 2003, the contents of which are hereby incorporated by reference as if stated herein in full. The print drive further includes an embossing detector 709 that may be used to sense when an embossed item, such as a conventional credit card, is inserted into the print module. The embossing detector may be a mechanical device, such as a limit switch, that contacts an inserted card and detects any embossing. If an embossed card is inserted into the rewritable card printer, the rewritable card printer may not attempt to write to the card, only read the card.

The print module further includes a security feature reading device 600 for reading any security features included in the card. The print module further includes a print head 604 for writing indicia to the rewritable card and an erase head 602 for erasing the indicia from the rewritable card. The print module further includes an optical scanning device 605 for scanning the indicia printed onto a rewritable card. The print module further includes a magnetic strip read/write head 607 used to read and write from and to a rewritable card's magnetic strip. The print module may also further include an optional print head 705 and read head 711 for reading and writing to write-once media. The print module is removably and electronically coupled to the printer controller and removably and mechanically coupled to the card magazine.

In operation, the print module receives printer control signals from the printer controller. In response to the printer control signals, the print module scans rewritable cards for the presence and value of any security feature in the rewritable card. As the print module scans the rewritable card, the security feature reading device generates a previously described security signature signal that is transmitted to the printer controller. In addition, the print module thermally prints on the rewritable cards, and thermally erases the rewritable cards, under the control of the printer controller. The print module may also receive a rewritable card from a player and transmit a rewritable card detection signal to the printer controller.

The print module may also include a static memory read/write connector 622 for coupling to a “smart” card having a readable/writable static memory. The printer controller transmits static memory write signals and receives static memory read signals to and from the static memory read/write head.

The one or more independently controlled card magazines store rewritable cards and provide the rewritable cards to the printer module on command from the printer controller. Each card magazine may includes one or more magazine card drives 710 for moving cards into and out of the magazine. Each card magazine also includes a card storage area 712 for storage of rewritable cards. In operation, the card magazine receives card magazine control signals from the printer controller. In response to the control signals, the card magazine feeds cards to the printer from the card storage area using the magazine card drive. In response to the card magazine control signals, the card magazine may also receive rewritable cards from the print module and store the rewritable cards in the card storage area. The card magazine may also include one or more card sensors 714 used to detect the number of cards stored in the card storage area. The card sensors sense the quantity of cards stored in the card storage area and transmit card count signals to the printer controller for further processing. The card magazine may also include a read/write static memory 715 for semi-permanent storage of card information about cards stored in the card magazine.

The printer controller includes a processor 716 coupled to a main memory 718 by a system bus 720. The printer controller also includes a storage memory 722 coupled to the processor by the bus. The storage memory stores programming instructions 113, executable by the processor to implement the features of a rewritable card printer. The storage memory also includes printer and card information 724 stored and used by the processor. The printer and card information includes information received by the printer controller about the status of the print module and card magazine and also about the status and identity of any cards stored in the card magazines or being operated on by the print module. The types of status information may include an image of a last printed rewritable card as scanned by the optical scanning device and the current status, such as millimeters of advancement, of a card currently in the print module.

The printer controller also includes an Input/Output (I/O) device 726 coupled to the processor by the system bus. The I/O device is used by the printer controller to transmit control signals to the print module and the card magazine. The I/O device may also be used by the printer controller to receive security feature and status signals from the print module and card magazine.

One or more communications devices 728 may be coupled to the system bus for use by the printer controller to communicate with a cashless gaming system host 102 or a game controller 108 (both of FIG. 1). The printer controller uses the communication devices to receive commands, program instructions, and card information from the external devices. In addition, the printer controller may use the communication devices to transmit printer status information to the external devices. Other communication devices may also be used by the printer controller to couple in a secure fashion over a local area network 732 for administrative or other purposes.

Additional communication devices and channels may be provided for communication with other peripheral devices as needed. For example, one communication device may be provided with a local communications port, accessible from an exterior of a gaming machine hosting the rewritable card printer, that a technician may use to communicate with the printer controller during servicing using an external controller 730. The external controller may communicate with the printer controller using an infrared link, other short-range wireless communication link, are a hard link with an external connector in a secure manner.

The processor may be further coupled to an encryption/decryption module 740 that may be used to encrypt and decrypt messages encoded using the an encryption standard. This enables the printer controller to engage in secure transactions with external devices. The processor may access the display device either as a component through the bus as shown or as an external device through a communications device using a high level communications protocol. In addition, the printer controller may also include program instructions to perform encryption/decryption services as well.

The processor may be further coupled to a display device 742 that may be used to display printer status information or card information. For example, the display may used to display an “as-scanned” version of the most recently printed and scanned card. The processor may access the display device either as a component through the I/O device or as an external device through a communications device.

In operation, the processor loads the programming instructions into the main memory and executes the programming instructions to implement the features of a rewritable card printer as described herein.

As illustrated, the printer controller is shown as being electronically coupled to the print module and card magazine without any mechanically coupling. The printer controller may be mounted in a variety of ways and may be incorporated into various components of either the rewritable card printer or the game hosting the rewritable card printer. For example, the printer controller may be attached to and supported by the print module, the card magazine, or the host game as may be required to mechanically integrate the rewritable card printer into the host game.

FIG. 7b is an architecture diagram of a rewritable card printer employing components having integral controllers in accordance with an exemplary embodiment of the present invention. A rewritable card printer 110 may be composed of a printer controller 606 that communicates with components and modules of the rewritable card printer using a communications link 749. The communications link may use either serial or parallel communications protocols to communicate with the components of the rewritable card printer. In this embodiment a print module 750 includes a print module controller 752 coupled to the printer controller. To control the operations of the print module, the printer controller transmits high level commands and status requests to the print module. In response, the print module performs the commands and transmits the requested information.

One or more card magazines 754 may also have integral card magazine controllers that are coupled to the printer controller via the communications link. To control the operations of the card magazine, the printer controller transmits high level commands and status requests to the card magazine. In response, the card magazine performs the commands and transmits the requested information to the printer controller.

The internal architecture of the rewritable card printer may be extended to external devices 758 as well, each having its own internal controller 760. In this embodiment, the printer controller communicates with the external device using high level commands. In response, the external device performs the commands and transmits any requested information to the printer controller. An example of an external device having its own internal controller includes an external card magazine or cassette used to load cards into, or retrieve cards from, the rewritable card printer.

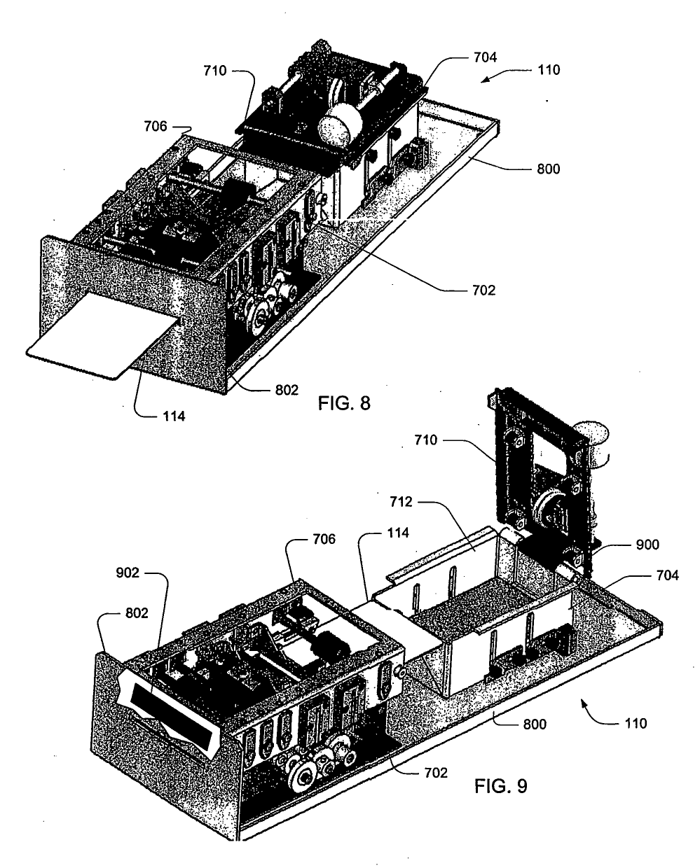

FIG. 8 is an isometric view of a rewritable card printer in accordance with an exemplary embodiment of the present invention. As illustrated, the rewritable card printer 110 includes a print module 702 and one or more card magazines 704 mechanically coupled on a base 800. The rewritable card printer includes a front bezel 802 through which a rewritable card 114 may be fed by the print module's print card drive 706, either into or out of the rewritable card printer as previously described. The card magazine is positioned on the base such that the card magazine's magazine card drive 710 may feed rewritable cards to and receive rewritable cards from the print module as previously described. The print module and the magazine drive are separately mounted to the base and each may separately serviced in the field without affecting the operation of the other. In addition, each component may be removed from the rewritable card printer and replaced without removing the power to the rewritable card printer.

As the print module and card magazine are separately mounted and controllable, the orientation of the print module and card magazine may be altered as needed to suit the mechanical requirements of a host game. For example the distance between the print module and the card magazine may be altered in order to accommodate a shorter printer bay included in a host game.

In one card magazine in accordance with an exemplary embodiment of the present invention, the cards are stored in the card magazine at an angle, up to 90 degrees, relative to the orientation to a card as it is fed into or out of a print module. This allows the card magazine to accommodate a larger number of cards in a given space, thus enhancing the card magazine's storage capabilities. In operation, the magazine card drive receives the card from the print module or another card magazine and tilts the card as it is added to the card storage area. When a card is retrieved from the card magazine, the magazine card drive reorients the card into a proper position for presentation to the print module.

FIG. 9 is an isometric view of a rewritable card printer with the card magazine opened in accordance with an exemplary embodiment of the present invention. As illustrated, the rewritable card printer 110 includes a print module 702 and one or more card magazines 704 mechanically coupled on a base 800. The rewritable card printer includes a front bezel 802 through which a rewritable card 114 may be fed by the print module's print card drive 706, either into or out of the rewritable card printer, as previously described. The card magazine is positioned on the base such that the card magazine's magazine card drive 710 may feed rewritable cards to and receive rewritable cards from the print module as previously described. The magazine card drive is removably coupled to the card storage area 712 by a hinge 900 such that the magazine may be opened to allow access to the card storage area.

A cleaning device 902 (shown through a cutaway in the front bezel 802) is attached to the print module such that incoming rewritable cards are cleaned before they enter the print module. The cleaning device may include flexible solid or bristled wiper elements that contact the card as it is taken into the print module. The wiper elements may be conductive so as to remove static surface charges from the card as it moves in the card printer. The wiper elements may also be charged so as to electrically attract and collect particles of dust and dirt from the card. As the print module's print card drive is reversible, the incoming card may be passed repeatedly, back and forth, through the cleaning element as needed.

In other print modules in accordance with other exemplary embodiments of the present invention, the cleaning device may be located within the print module, within the card magazine, or between the print module and a card magazine. In other rewritable card printers in accordance with exemplary embodiments of the present invention, the cleaning device is a separate device and not integrated with either a print module or a card magazine. Instead, the cleaning device is a separate motorized device similar to a card magazine and is electronically coupled to a printer controller.

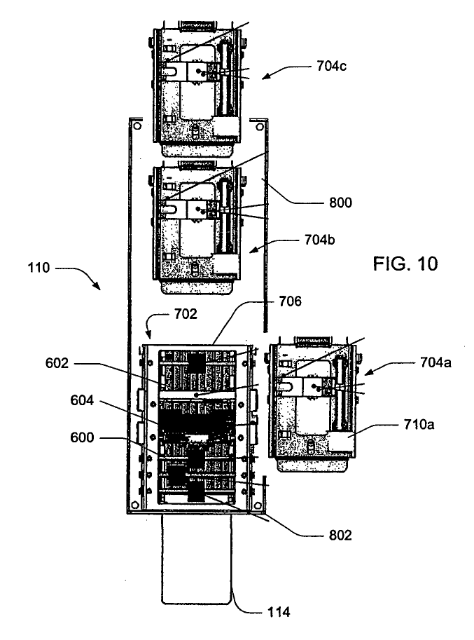

FIG. 10 is a top plan view of a rewritable card printer in accordance with an exemplary embodiment of the present invention. The rewritable card printer 110 includes a print module 702 and one or more card magazines 704a, 704b, and 704c that are mechanically coupled on a base 800. The rewritable card printer includes a front bezel 802 through which a rewritable card 114 may be fed by the print module's print card drive 706, either into or out of the rewritable card printer, as previously described. The plan view also illustrates a possible relative position of a security feature reading device 600, a print head 604, and an erase head 602 within the print module. Card magazine 704a is positioned on the base such that the card magazine's magazine card drive 710a may feed rewritable cards to and receive rewritable cards from the print module as previously described.

In the top view, additional positions for card magazines are illustrated. These additional card magazine positions may be used to mount one or more card magazines in various relationships to the print module as may be dictated by an existing printer bay in a host game. In one possible configuration, a card magazine 704a is located to the side of the print module. In another configuration, two card magazines, 704b and 704c, are mounted such that the card magazines may feed and receive rewritable cards to and from each other as companions. As illustrated, card magazine 704b is the primary card magazine and may feed cards into and receive cards from the print module. Card magazine 704c is a secondary card magazine that may feed cards to and receive cards from the primary card magazine.

Card magazines configured so as to allow movement of cards between the card magazines are herein termed “companion” magazines. Companion card magazines may be used to move rewritable cards around such that individual rewritable cards may be identified and retrieved from storage. This is because a card magazine with a single magazine card drive may be used as a Last In First Out (LIFO) rewritable card “memory” where the last rewritable card placed into the card magazine will be the first rewritable card retrieved from the card magazine when a rewritable card is requested. Through the use of multiple magazine drives serving a single rewritable card storage location, different styles of rewritable card memories may be implemented such as a First In First Out (FIFO) memory.

Companion card magazines may also be used to store different kinds of rewritable cards for use by the rewritable card printer. For example, the rewritable cards may have different permanent graphics imprinted on them indicating different user affiliations such as affiliations to different loyalty reward programs. In this way, a user may “upgrade” their affiliations by inserting a first style of rewritable card into the rewritable card printer and exchange it for a second style of rewritable card.

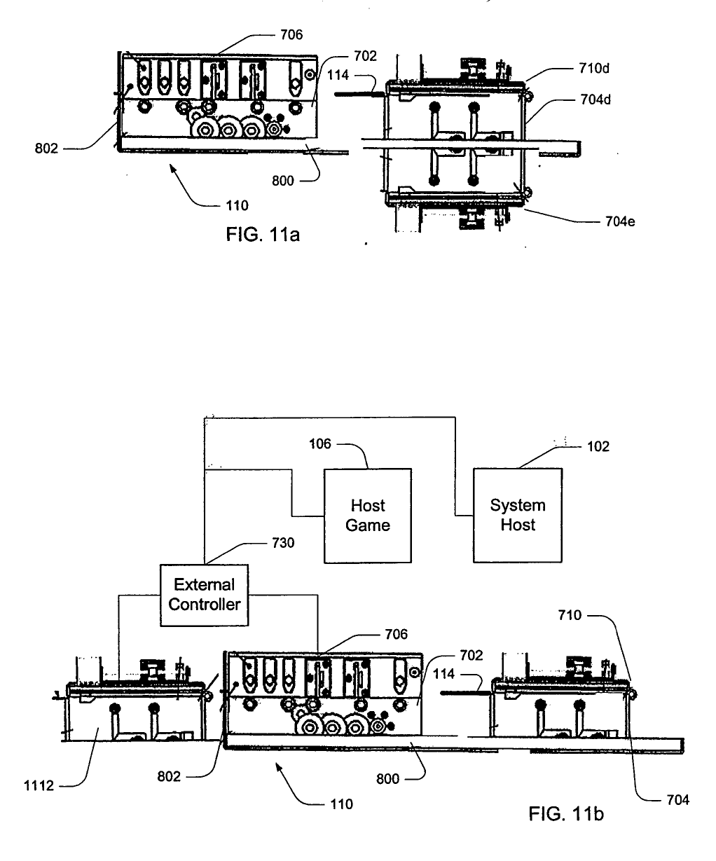

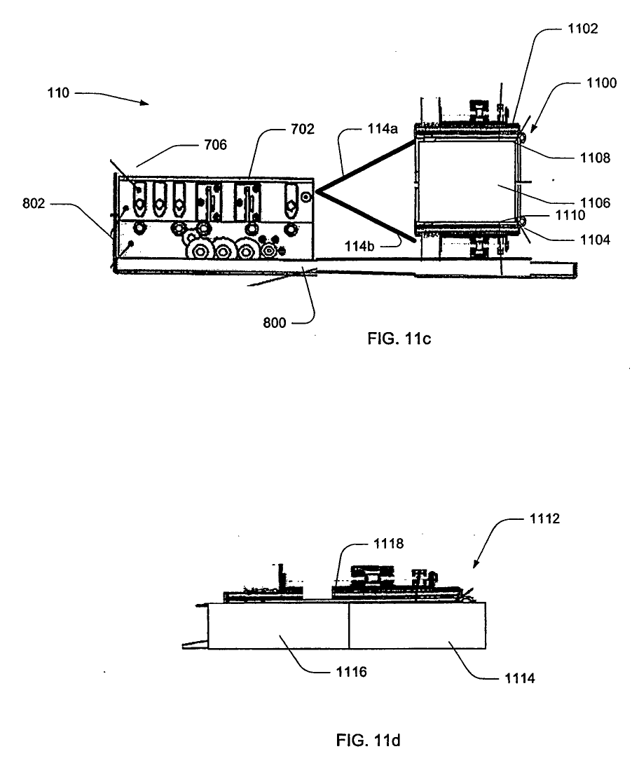

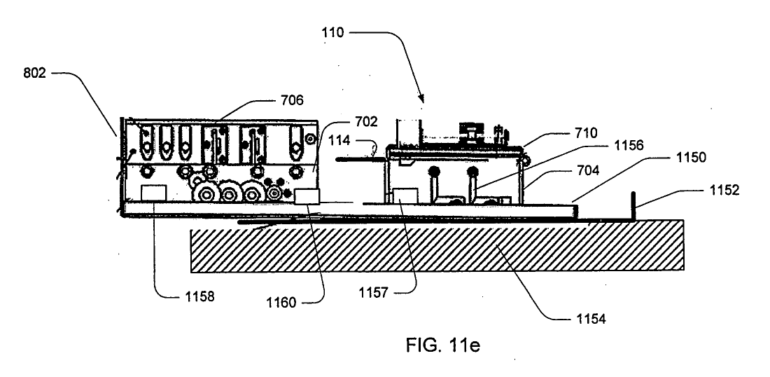

FIG. 11a is side elevation view of a rewritable card printer in accordance with an exemplary embodiment of the present invention. The rewritable card printer 110 includes a print module 702 and one or more card magazines 704d and 704e mechanically coupled to a base 800. The rewritable card printer includes a front bezel 802 through which a rewritable card may be fed by the print module's print card drive 706, either into or out of the rewritable card printer as previously described. Card magazine 704d is positioned on the base such that the card magazine's magazine card drive 710d may feed rewritable cards to and receive rewritable cards from the print module as previously described.

In the side view, an additional position for a card magazine is shown as card magazine 704e located beneath card magazine 704d. This position may be used to mount a card magazine as either a previously described primary or secondary card magazine. In addition, card magazine 704e may be replaced by a larger card storage area for card magazine 704d that extends through the base.

FIG. 11b is side elevation view of a rewritable card charging and retrieval process in accordance with an exemplary embodiment of the present invention. The rewritable card printer 110 includes a print module 702 and a card magazine 704 mechanically coupled to a base 800. The rewritable card printer includes a front bezel 802 through which a rewritable card may be fed by the print module's print card drive 706, either into or out of the rewritable card printer as previously described. Card magazine 704 is positioned on the base such that the card magazine's magazine card drive 710 may feed rewritable cards to and receive rewritable cards from the print module as previously described.

A technician may use an external controller 730 electronically coupled to the rewritable card printer and to an external card magazine 1112 removable and mechanically coupled to the rewritable card printer to load rewritable cards into and retrieve cards, such as escrowed cards, from the rewritable card printer. This may be done without opening a cabinet in a game hosting the rewritable card printer. To load cards into the rewritable card printer, the technician couples the external controller and external card magazine to the rewritable card printer. The technician then uses the external controller to send a card load signal to the rewritable card printer and the external card magazine. In response to the card load signal, the external card magazine dispenses cards into the rewritable card printer print module. In response to the card load signal, the print module accepts the dispensed cards and forwards them to an appropriate internal card magazine in the rewritable card printer.

To retrieve cards from the rewritable card printer, the technician couples the external controller and external card magazine to the rewritable card printer. In response to the card retrieval signal, the rewritable card printer retrieves cards from the rewritable card printer's one or more internal card magazines and dispenses the cards using the printer module. In response to the card retrieval signal, the external card magazine receives the dispensed cards from the rewritable card printer and stores them.

Optionally, the external print controller may store the number of rewritable cards loaded into the rewritable card printer, an identification of each of the rewritable cards loaded into the rewritable card printer, and an identifier of the rewritable card printer.

To keep track of the rewritable cards held by the rewritable card printer, the rewritable card printer may receive from the external controller a rewritable card identifier for each card dispensed by the external card magazine. The rewritable card printer may also scan each rewritable card for its identifier as each rewritable card is dispensed into the rewritable card printer.

In one rewritable card printer in accordance with an exemplary embodiment of the present invention, the rewritable card printer's printer controller contains all of the program instructions necessary to perform card loading and retrieval operations. In this embodiment, the external card magazine couples electronically with the rewritable card printer's printer controller and the rewritable card printer's printer controller commands the external card magazine to dispense and receive cards. The external controller may also communicate directly to the host game 106 or the system host 102.

An external controller may be implemented in a variety of different external devices. For example, the external controller may be a purpose-built controller. Other external controllers may be implemented in a programmable device such a Personal Digital Assistant (PDA) or a portable or “laptop” computer.

FIG. 11c is a side elevation view of a rewritable card printer with a card magazine having two independent magazine card drives in accordance with an exemplary embodiment of the present invention. The rewritable card printer 110 includes a print module 702 and a card magazine 1100 mechanically coupled to a base 800. The rewritable card printer includes a front bezel 802 through which a rewritable card may be fed by the print module's print card drive 706, either into or out of the rewritable card printer as previously described.

Card magazine 1100 includes a first magazine card drive 1102 and a second magazine card drive 1104. The card is positioned on the base such that the card magazine's magazine card drives may feed rewritable cards, 114a and 114b, to and receive rewritable cards from the print module using the same card storage area 1106. The first magazine card drive receives and dispenses cards from a first end 1108 of the card storage location. The second card magazine drive receives and dispenses cards from a second end 1110 of the card storage location. In this way, the card magazine may be used as a LIFO card storage device or a FIFO card storage device depending on whether two drives or one drive are employed. In addition, the magazine card drives may be used to store cards in the card storage location at an angle, such as at a 90 degree angle, relative to the orientation of the card while the card is being operated on by the printer module.

FIG. 11d is a side elevation view of a card magazine having a plurality of card storage locations serviced by a single card magazine drive. A card magazine 1112 may have a plurality of card storage locations, such as card storage locations 1114 and 1116. A single magazine card drive 1118 may service both card storage locations. In this way, a single card magazine may be used to shuffle cards to locate specific cards or rotate cards in storage to even out erase and write cycles performed on the cards.

FIG. 11e is side elevation view of a rewritable card printer slidably coupled to a gaming machine in accordance with an exemplary embodiment of the present invention. The rewritable card printer 110 includes a print module 702 and a card magazine 704 mechanically coupled to a printer base 1150. The rewritable card printer includes a front bezel 802 through which a rewritable card may be fed by the print module's print card drive 706, either into or out of the rewritable card printer as previously described. Card magazine 704 is positioned on the base such that the card magazine's magazine card drive 710 may feed rewritable cards 114 to and receive rewritable cards from the print module as previously described.

The printer base is further slidably coupled to a base plate 1152 that is fixedly coupled to a portion 1154 of a gaming machine hosting the printer. The rewritable card printer may be accessed while still in the gaming machine by sliding the rewritable card printer out of the gaming machine. The card magazine may be mechanically coupled to the printer base by a quick disconnect 1156 so that the card magazine may be easily removed. To facilitate easy removal, the card magazine may be coupled to the printer controller 606 (of FIG. 7a) by a quick disconnect electrical connector 1157 that allows the card magazine to be installed, removed, or exchanged without removing the power to the gaming machine or rewritable card printer.

The print module may be mechanically coupled to the printer base by a quick disconnect 1158 so that the print module may be easily removed. To further facilitate easy removal, the print magazine may be coupled to the printer controller 606 (of FIG. 7a) by a quick disconnect electrical connector 1160 that allows the print module to be installed, removed, or exchanged without removing the power to the gaming machine or rewritable card printer.

In one embodiment of a card magazine, the card magazine is slidably coupled to the printer base separately from the print module. In this embodiment, the card magazine may accessed by sliding the card magazine past the print module so that the card magazine may be separately serviced.

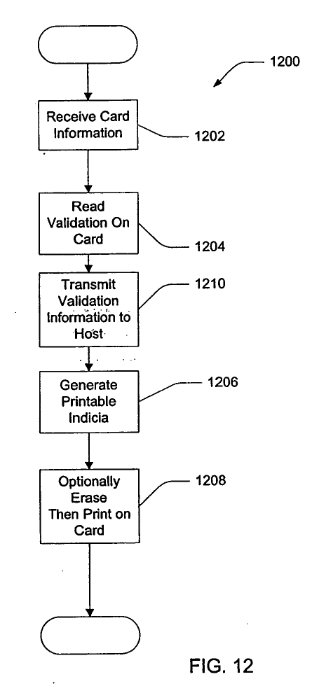

FIG. 12 is a process flow diagram of a rewritable card printing process in accordance with an exemplary embodiment of the present invention. During a printing process 1200, a rewritable card printer receives (1202) rewritable card information such as cash-out value or images to print onto the rewritable card. The rewritable card printer reads (1204) any security feature embedded in the rewritable card, storing the resultant security signature signal in temporary memory. The rewritable card printer generates (1206) indicia to print onto the rewritable card using the rewritable card values or images. Additionally, the rewritable card printer may incorporate all or a portion of security signature signal into the printed indicia as either a clearly readable value or an encoded value. The rewritable card printer then optionally erases (1208) the rewritable card and then prints the indicia onto the rewritable card prior to dispensing the rewritable card. The rewritable card printer may then transmit (1210) the security signature signal, either as an encoded value or as a clearly readable value, to a game host or cashless enabled system host.

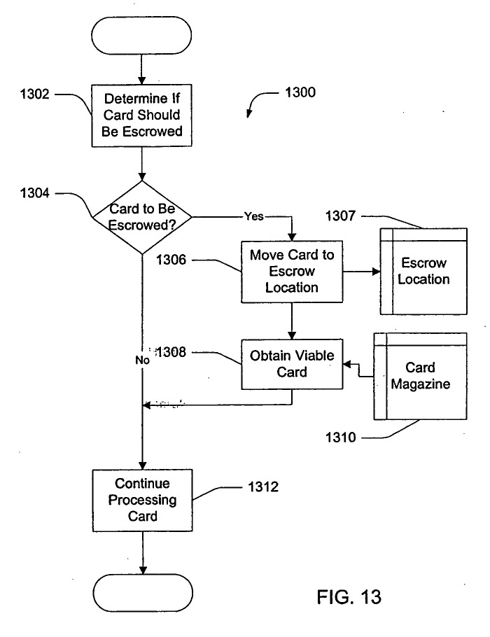

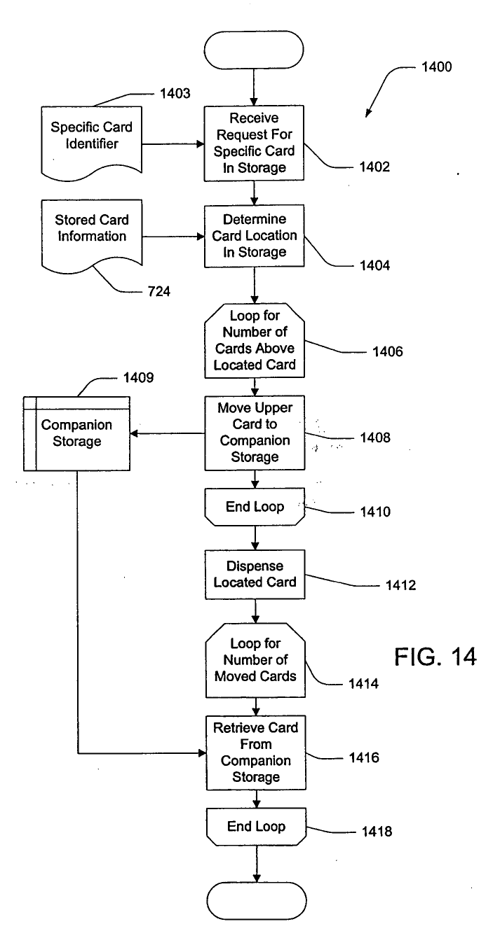

FIG. 13 is a process flow diagram of a card escrowing process used by a rewritable card printer in accordance with an exemplary embodiment of the present invention. In a card escrowing process 1300, a rewritable card printer determines if a card should be removed from service. A card may be removed from service for a variety of reasons. Rewritable cards have a finite number of erase and write cycles and so must be removed from service as they age. A card may become damaged so that it is no longer operable within rewritable card printer or the rewritable card's security feature is no longer readable. Cards may also have physical features such as embossing that may require the card to be handled in a special manner. As the rewritable card printer includes an optical scanner and can verify if a card was printed properly immediately after printing the card, the rewritable card printer may determine that a card was printed in error and may escrow the card. In addition, the rewritable card printer may receive an identifier for a rewritable card to be removed from service. In which case, the security feature in the rewritable card may be readable but correspond to a card to be removed from service. Another reason a card may be escrowed is that the user is exchanging one kind of rewritable card for another kind of rewritable card.

Cards may be removed from service by moving the card into an escrow location within the rewritable card printer by either a magazine card drive or by a print card drive. In the escrow process, the rewritable card determines (1302) if a card should be removed from service. If the rewritable card printer determines that the card should remain in service (1304), the rewritable card continues processing (1306) the rewritable card. Otherwise, the rewritable card printer moves (1306) the rewritable card to an escrow location 1307 within the rewritable card printer and obtains (1308) a replacement card from a card magazine 1310 and continues processing (1312) the newly obtained rewritable card.

FIG. 14 is a card retrieval process used by a rewritable card printer having companion magazines in accordance with an exemplary embodiment of the present invention. As noted previously, a card magazine having a single magazine card drive may be considered as being similar to a LIFO memory device. As previously noted, a rewritable printer controller may store information about cards stored in the card magazines. This information may include where in a card magazine a particular rewritable card is stored. In this case, a specific card stored in the card magazines may be retrieved using the following process.

In a card retrieval process 1400, a rewritable card printer receives a request for a specific rewritable card from an external host or a game controller. The rewritable card printer receives (1402) the request and determines (1404) where in the storage areas of the card magazines that the specific card is located using previously stored card information 704. For the number of cards on top of the request card, the rewritable card moves (as indicated by loop structure 1406, to 1410) all of the cards on top of the requested card into a companion card magazine's storage area 1409. The rewritable card printer then dispenses (1412) the located card. Optionally, the rewritable card printer may replace all of the moved cards from the companion card magazine (as indicated by loop structure 1414, 1416, and 1418).

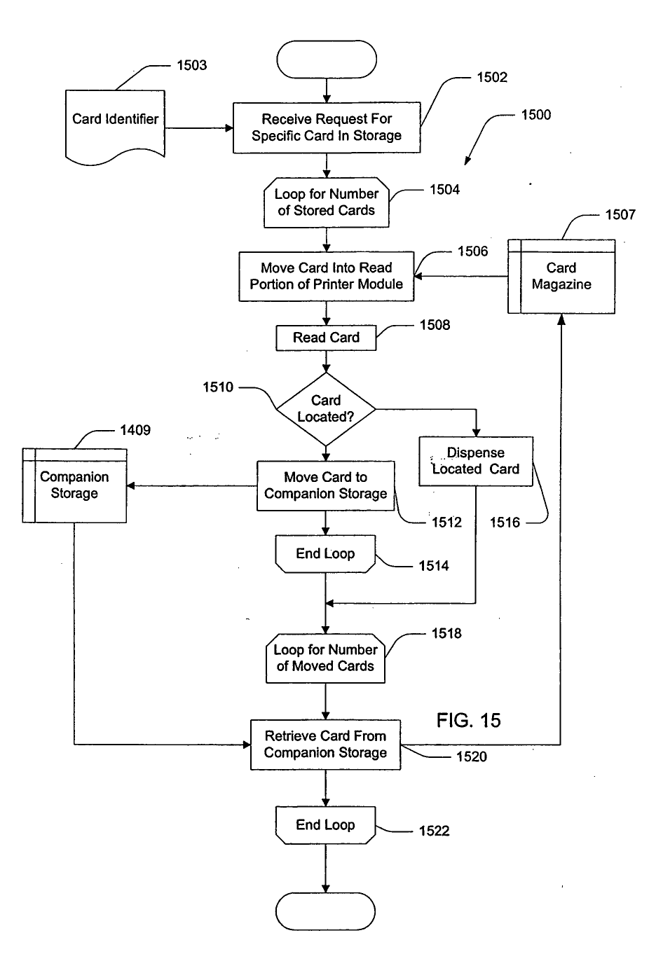

FIG. 15 is a process flow diagram of a card location process used by a rewritable card printer having multiple card magazines in accordance with an exemplary embodiment of the present invention. This card location process, 1500, may be used when the rewritable card printer does not keep an accounting of each writeable card stored in the rewritable card printer's memory. The rewritable card printer receives (1502) an identifier for a card to be located. For each rewritable card stored by the rewritable card printer in a card magazine (as indicated by the loop structure 1504 to 1514), the rewritable card printer moves (1506) a rewritable card from a card magazine 1507 into a read portion of the print module 702 (of FIG. 7) and reads (1508) an identifier, such as a previously described security feature, from the rewritable card. The rewritable card printer then compares (1510) the read identifier to the received identifier. If the comparison indicates that the requested rewritable card is located, the rewritable card printer dispenses (1516) the located card. If the comparison indicates that the retrieved rewritable card is not the requested rewritable card, the rewritable card printer moves the card into a companion card magazine's storage location 1409 and continues processing rewritable card until either the requested card is located or the last of the stored rewritable cards is retrieved.

Optionally, the rewritable card printer may put all of the moved rewritable cards back into their original locations within a card magazine. For each of the moved cards (as indicated by the loop structure 1518 to 1522) the rewritable card printer retrieves (1520) a moved card out of the companion storage location and places it back into the card magazine 1507.

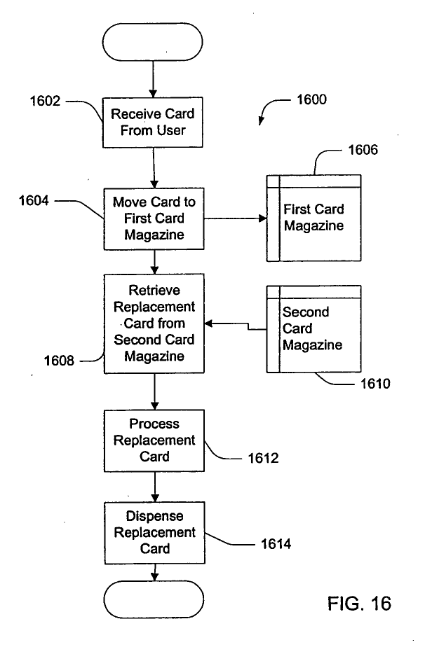

FIG. 16 is a process flow diagram of a card replacement process in accordance with an exemplary embodiment of the present invention. A rewritable card printer may include two or more card magazines as previously discussed. This feature allows a gaming machine to be used for more sophisticated transactions than merely accepting wagers, playing games, and printing cash-out cards. Using multiple card magazines allows a gaming machine to also function as a customer service kiosk for several types of operations wherein a player may exchange one type of rewritable card for another during a transaction. An example of such a transaction is when a player wants to join a loyalty program.

In a card replacement process 1600, a rewritable card printer receives (1602) a card from a user for imprinting. The rewritable card printer moves (1604) the received card into a first card magazine 1606 for storage and possible reuse. The rewritable card printer then retrieves (1608) a replacement card from a second card magazine 1610. The rewritable card printer continues processing (1612) the replacement card such as by printing on the card as previously described. The rewritable card printer dispenses (1614) the imprinted replacement card to the user whereby the user's original card has been replaced with another type of card.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

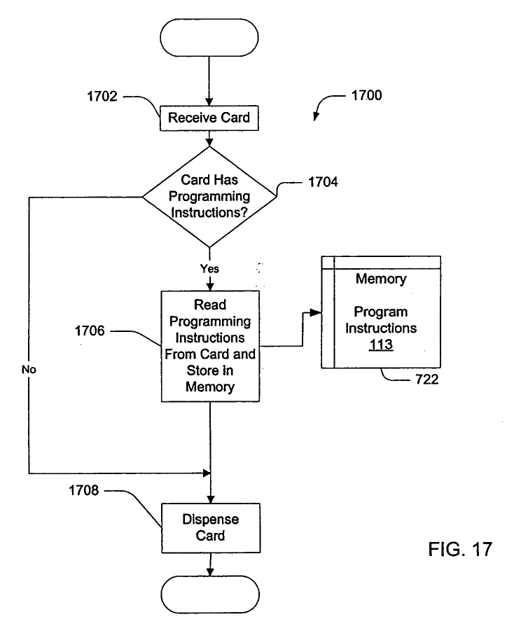

FIG. 17 is a process flow diagram of a programming process using a rewritable card in accordance with an exemplary embodiment of the present invention. A rewritable card printer may use a rewritable card to load programming instructions into memory. The rewritable card may include programming instructions in a magnetic strip readable by the rewritable card's magnetic strip read/write head, or programming instructions may be included in the printed indicia on the card and read by an optical scanning device.

In a programming process 1700, a rewritable card printer receives (1702) a card and determines (1704) if the card includes programming instructions. A rewritable card printer may make the determination by either scanning the card and parsing the information found on the card or may be signaled by an external device that the inserted card includes programming instructions. If the card does have programming instructions, the rewritable card printer reads (1706) the programming instructions and stores the programming instructions 113 in the rewritable card printer's memory 722. After reading the card, the rewritable card printer dispenses the card 724. In addition to reading rewritable cards to obtain additional programming instructions, the rewritable card printer may receive programming instructions from an external device, such as external controller 730 (of FIG. 7a).

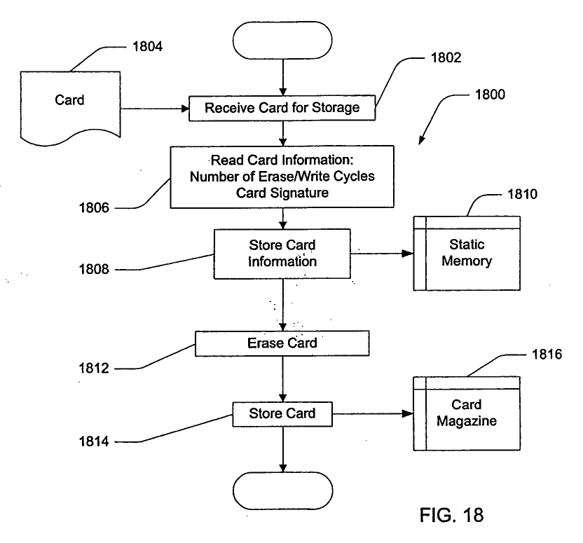

FIG. 18 is a process flow diagram of a card information storage process in accordance with an exemplary embodiment of the present invention. A rewritable card printer receives (1802) a card 1804 for storage into a card magazine. The rewritable card printer reads (1806) card information from the card. The card information may include the number of erase/write cycles that the card has gone through and the unique signature of the card. The rewritable card printer stores (1808) the card information in static memory 1810. The static memory may be on the card itself, in a card magazine, or in a static memory location in the printer controller. Once the card information has been stored, the writable card printer erases (1812) the card and stores (1814) the erased card in a card magazine 1816.

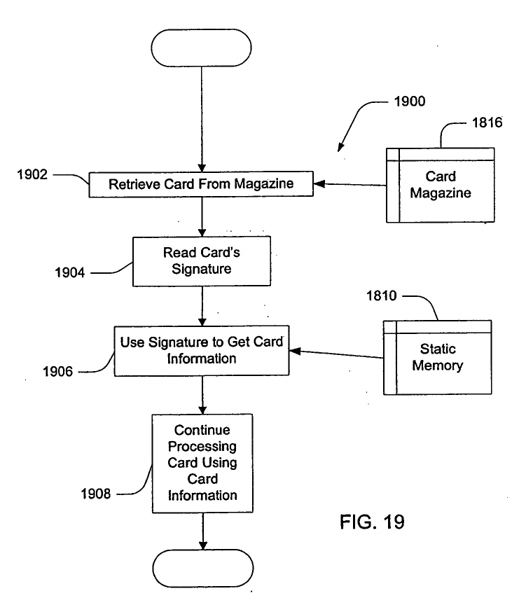

FIG. 19 is a process flow diagram of a card information retrieval process in accordance with an exemplary embodiment of the present invention. A card retrieval process 1900 is used by a rewritable card printer to initiate writing on to an erased card. The card's information, including information about how many read/write cycles the card has gone through, is stored in static memory 1810 as previously described. This enables a rewritable card printer to safely store rewritable cards in an erased mode and still track card usage in order to determine when a card should be removed from service.

The rewritable card printer retrieves (1902) a card from a card magazine 1816. The rewritable card printer reads (1904) the cards signature and uses (1906) the card's signature to retrieve card information from the static memory. The rewritable card printer then continues (1908) processing the rewritable card using the retrieved card information. This may include incrementing the number of erase/write cycles that the card has gone through onto the card before dispensing the card. This processing may also include removing the card from service.

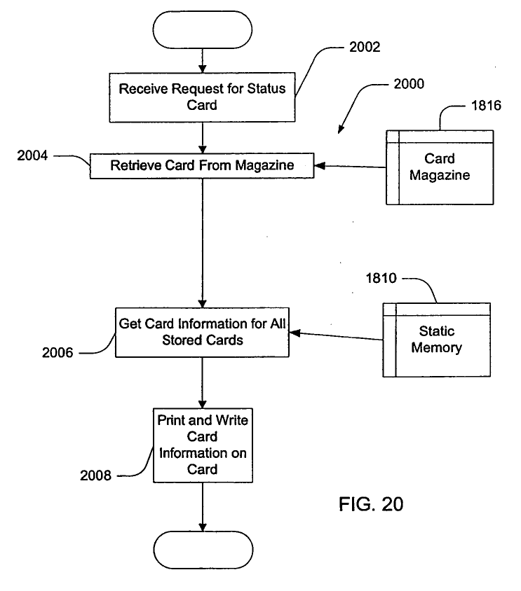

FIG. 20 is a stored card status printing process in accordance with an exemplary embodiment of the present invention. A rewritable card printer uses a stored card status printing process 2000 to report on a rewritable card the status of the rewritable card printer, game host, and rewritable cards stored by the rewritable card printer. The rewritable card printer receives 2002 a request for printing a status card. The in response to the request, the rewritable card printer retrieves (2004) a card from the card magazine 1816. The rewritable card printer retrieves (2006) card information stored in static memory 1810 about the cards stored by the rewritable card printer. The rewritable card printer then uses the card information to generate printable indicia for printing (2008) on the card and prints the indicia on the card before dispensing it.

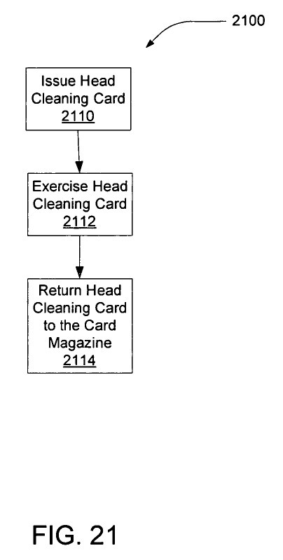

FIG. 21 is a process flow diagram of a head cleaning process 2100 in accordance with an exemplary embodiment of the present invention. The process is employed by the rewritable card printer to clean the heads of the print module. During the process, the external card magazine issues (2110) a special head cleaning card into the rewritable card printer. The rewritable card printer then exercises (2112) the head cleaning card back and forth with the erase, read and write heads deployed, thereby accomplishing cleaning the heads and the card drive mechanism.

After this process, the cleaning card is returned (2114) to the external card magazine. In this manner the heads are cleaned with each new card loading. Signaling of the use of the cleaning card can be driven by either the rewritable card printer or the external card magazine device.

In another aspect of the head cleaning process, the external card magazine holds the head cleaning card in a specified storage location within the external card magazine.

In another aspect of the head cleaning process, the rewritable card printer stores and tracks a head cleaning card in a second internal card magazine, such as a waste or escrow card magazine. After a pre-determined time or number of cards are processed by the rewritable card printer, the printer shuffles out any waste or escrowed cards into a source card magazine until it locates the head cleaning card. The printer then exercises the cleaning card through the card pathway as described above, and then replaces the head cleaning card in the waste magazine, followed by the waste cards temporarily placed into the source magazine.

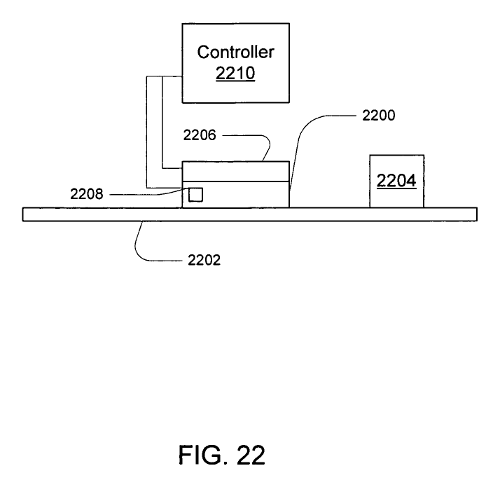

FIG. 22 is a schematic diagram of a card cooling system in accordance with an exemplary embodiment of the present invention. In the card cooling system, a bar 2200 which is cooled to a temperature lower than the ambient temperature, is thermally coupled, such as by conduction, convection or radiation, to a rewritable card 2202 after the rewritable card is written to by a thermal print head 2204. This serves to rapidly lower the temperature of the card shortly after the rewritable card is printed. The bar may cooled by a variety of methods, such as a Peltier device 2206. In addition, a temperature sensor 2208, such as a thermistor or other temperature sensing device, may be present on the bar to provide feedback to a controller 2210 in order to allow a consistent cold temperature to be realized.

In one aspect of an exemplary cooling system, the bar is a roller.

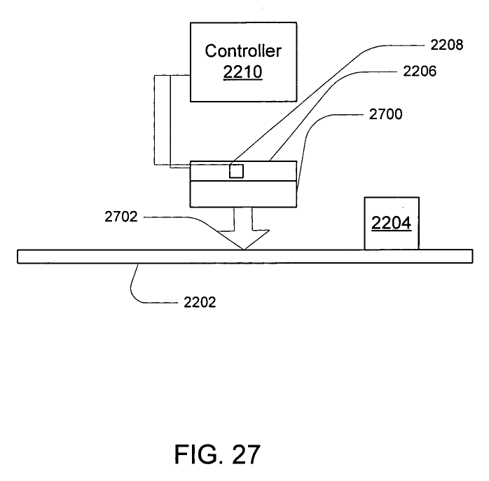

FIG. 27 is a schematic diagram of a fan-based card cooling system in accordance with an exemplary embodiment of the present invention. In the fan-based card cooling system, a fan 2700 coupled with a cooling device 2206 provides cooled air 2702 to cool a rewritable card 2202 after the rewritable card is written to by a thermal print head 2204. In addition, a temperature sensor 2208, may be present on the cooling device to provide feedback to a controller 2210 in order to allow a consistent cold temperature to be realized.

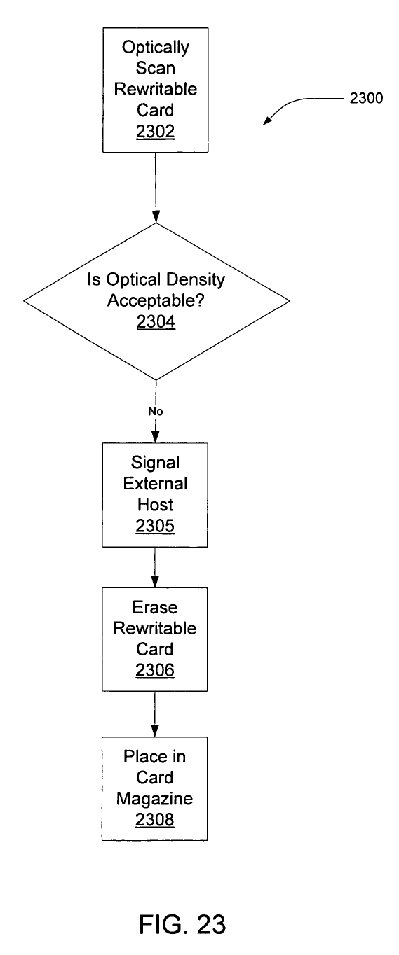

FIG. 23 is a process flow diagram of a pre-scan process 2300 in accordance with an exemplary embodiment of the present invention. In the process, a rewritable printer optically scans (2302) a rewritable card, when the rewritable card is inserted, to determine (2304) the optical density of any thermal printing on the rewritable card. If the optical density is poor, the rewritable card printer signals (2305) an external host, such as a card tracking server, that the rewritable card is no longer usable. When signaled in return, the rewritable card printer erases (2306) the rewritable card and places (2308) the rewritable card in a waste or escrow card magazine.

In another aspect of the pre-scan process, the optical density measurement is stored for the rewritable card and kept in non-volatile memory. When the card is re-printed, the measurement can be used to adjust the heating process, both for erasure and recording the indicia. This measurement follows the card within the source card magazine, and is erased when the rewritable card is used and issued, or removed from a card loading/unloading external card magazine.

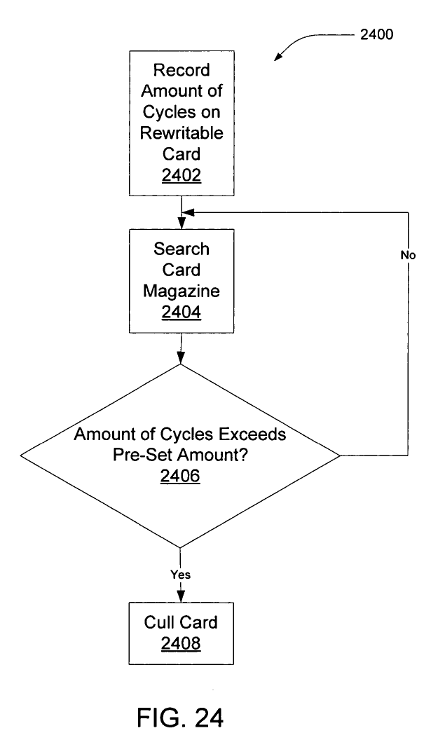

FIG. 24 is a process flow diagram of using a rewritable card cycle history when processing cards in accordance with an exemplary embodiment of the present invention. When processing (2400) a rewritable card, such as writing to it, the number of erase/print cycles the card has experienced is stored (2402) on the card. This may be done by writing special indicia, in a magnetic stripe or in the memory of the rewritable card if it is also a smart card. This information may be used in a variety of ways. In one example, a rewritable card printer or an auxiliary device which interfaces to a card magazine searches (2404) the rewritable cards stored in the card magazine. When a rewritable card has exceeded (2406) a pre-set amount of cycles, the rewritable card is culled (2408).

In another exemplary embodiment of the present invention, the culling device calculates the amount of usable life remaining in the rewritable cards which it has processed as an average and as a total of the rewrite cycle count.

In another exemplary embodiment of the present invention, during a rewritable card unloading or loading process, the culling device unloads all cards over a certain amount of cycles. This allows a gaming establishment, such as a casino, to cull out old cards, on the gaming floor. The card magazine loader would may be programmed with the amount of rewritable cards which were desired in order to instruct the culling device as to a cycle count trigger threshold. The threshold may also be signaled to the culling device by an external device which communicates with the culling device.

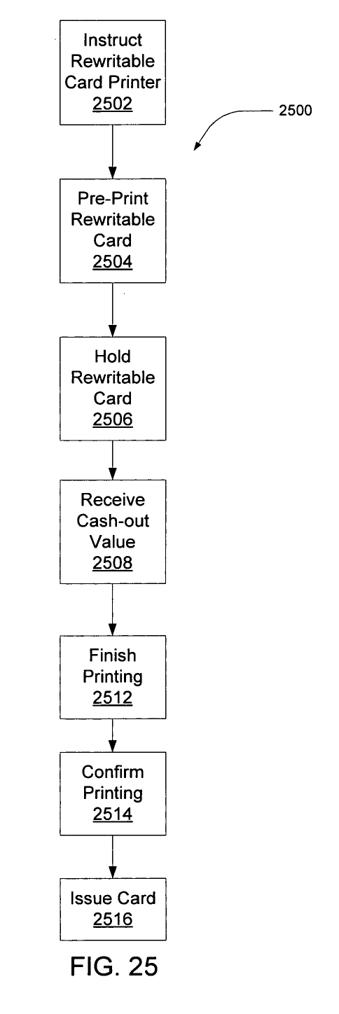

FIG. 25 is a process flow diagram of a pre-print process 2500 in accordance with an exemplary embodiment of the present invention. In this process, a rewritable card printer, coupled to a controlling system host, is instructed (2502) to pre-print (2504) all information on a rewritable card with the exception of the cash-out amount. The rewritable card is held (2506) in this state until cash-out. At that point, a final authorization to proceed is received (2508), along with the cash-out value. Then, the rewritable card printer need only print (2512) the cash-out amount. Once confirmation that the printing is complete (2514), then the authorizing system records an authorization code associated with the cash-out amount are valid for redemption. The rewritable card printer is then instructed to issue (2518) the rewritable card.

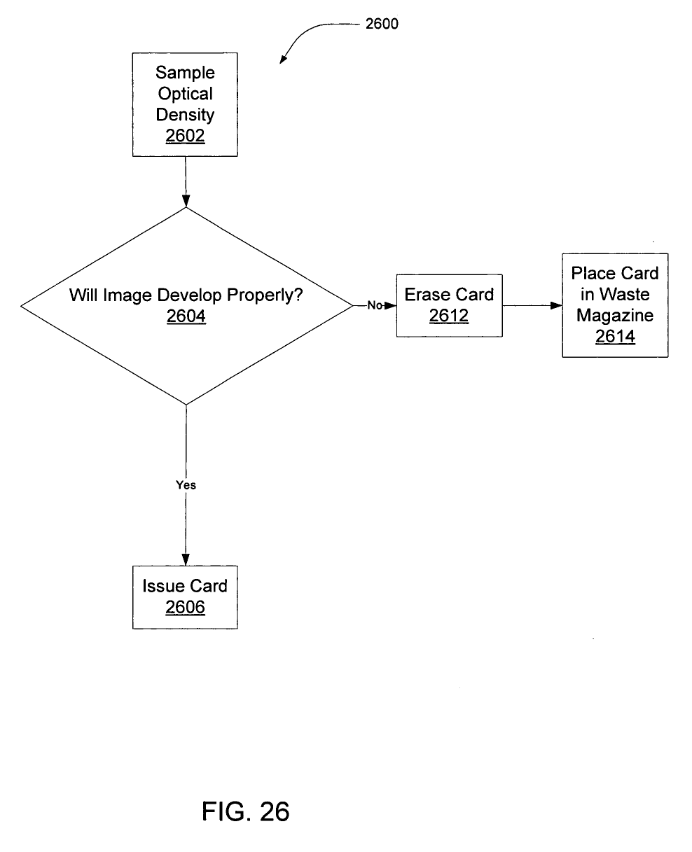

FIG. 26 is a process flow diagram of a benchmark scanning process 2600 in accordance with an exemplary embodiment of the present invention. The benchmark scanning process is used to determine if a card will develop an acceptable image as re-writable cards can take several minutes to fully develop. In the benchmark scanning process, the optical density of a rewritable card is sampled and measured (2602) shortly after printing. Based on that measurement, a determination is made (2604) if the indicia written to the rewritable card will develop to an acceptable level within a reasonable amount of time. If the optical density measurement taken after the initial print indicates that an anticipated optical density at a short amount of time in the future will be within an acceptable range, the rewritable card is allowed to be issued (2606). If not, the rewritable card is erased (2612) and placed (2614) into an escrow card magazine or waste bin. Another rewritable card is then pulled (2606) from a supply card magazine to replace the faulty rewritable card.

In another exemplary embodiment of the benchmark scanning process, the scanning process is repeated after a time delay to re-check the optical density reading.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. A method of cleaning a rewritable card printer, comprising:
issuing a head cleaning card from a card magazine into the rewritable card printer;
exercising the rewritable card back and forth within the rewritable card printer, thereby cleaning a head within the rewritable printer; and
returning the head cleaning card to the card magazine.

2. The method of claim 1, further comprising receiving by the card magazine a signal from the rewritable card printer to issue the head cleaning card.

3. The method of claim 1, further comprising receiving by the rewritable card printer a signal from the card magazine that the head cleaning card is to be issued.

4. The method of claim 1, wherein the card magazine is external to the rewritable card printer.

5. The method of claim 1, wherein the card magazine is internal to the rewritable card printer.

6. The method of claim 1, wherein the card magazine includes a specified storage location for storing the head cleaning card.

7. The method of claim 1, wherein the card magazine is used by the rewritable card printer to store unused rewritable cards, the method further comprising:
determining by the rewritable card printer a location of the cleaning card within the card magazine; and
shuffling cards between the card magazine and a second card magazine in order to issue the cleaning card from the card magazine.

8. A rewritable card printer having cooling unit that cools a rewritable card after it has been printed.

9. The rewritable card printer of claim 8, wherein the cooling unit includes a bar thermally coupled to the rewritable card.

10. The rewritable card printer of claim 8, wherein the cooling unit includes a roller thermally coupled to the rewritable card.

11. The rewritable card printer of claim 8, wherein the cooling unit includes a fan.

12. The rewritable card printer of claim 8, wherein the cooling unit includes a Peltier cooling device.

13. The rewritable card printer of claim 8, wherein the cooling unit includes a temperature sensor.

14. A method of processing a rewritable card by a rewritable card printer, comprising:
scanning a received rewritable card to determine the optical density of the indicia on the card; and
removing the rewritable card from service if the optical density indicates the card is no longer usable.

15. The method of claim 14, further comprising signaling an external host to indicate that the rewritable card is no longer usable.

16. A method of processing a rewritable card by a rewritable card printer, comprising:
scanning a received rewritable card to determine the optical density of the indicia on the card;
storing the optical density measurement; and
using the optical density measurement to adjust a heating process applied to the rewritable card.

17. The method of claim 16, wherein the heating process is used to erase the rewritable card.

18. The method of claim 16 wherein the heating process is used to create indicia on the rewritable card.

19. The method of claim 16, further comprising tracking the rewritable card when it is stored in a card magazine in order that the heating process may be adjusted when the card is utilized.

20. A method of processing a rewritable card comprising recording on the card an amount of erase/print cycles.

21. The method of claim 20, wherein the amount of erase/print cycles is recorded in printed indicia.

22. The method of claim 20, wherein the amount of erase/print cycles is recorded in a magnetic stripe.

23. The method of claim 20 wherein the rewritable card is a smart card having a memory and the amount of erase/print cycles is recorded in the memory.

24. The method of claim 23, further comprising using the recorded amount of erase/print cycles to cull the rewritable card based on the amount of erase/print cycles.

25. The method of claim 24, further comprising using a number of cards for a rewritable card printer and the recorded amount of erase/print cycles to cull the rewritable card.

26. The method of claim 20, further comprising determining the usable life remaining in a plurality of rewritable cards using amounts of erase/print cycles read from the plurality of rewritable cards.

27. A method of processing a rewritable card, comprising:
partially printing cash-out data on the rewritable card;
holding the rewritable card until a cash-out signal is received; and
printing a remainder of the cash-out data on the rewritable card.

28. A method of processing a rewritable card, comprising:
sampling an optical density of the rewritable card after printing to the rewritable card; and
determining if the card image will develop a readable image based on the sampled optical density.

29. The method of claim 28, further comprising repeating the sampling periodically to re-check the optical density reading.

30. A rewritable card printer, comprising:
means for receiving a head cleaning card from a card magazine into the rewritable card printer;
means for exercising the rewritable card back and forth within the rewritable card printer, thereby cleaning a head within the rewritable printer; and
means for returning the head cleaning card to the card magazine.

31. The rewritable card printer of claim 30, further comprising means for transmitting to the card magazine a signal to issue the head cleaning card.

32. The rewritable card printer of claim 30, further comprising means for receiving a signal from the card magazine that the head cleaning card is to be issued.

33. The rewritable card printer of claim 30, wherein the card magazine is external to the rewritable card printer.

34. The rewritable card printer of claim 30, wherein the card magazine is internal to the rewritable card printer.

35. The rewritable card printer of claim 30, wherein the card magazine includes a specified storage location for storing the head cleaning card.

36. The rewritable card printer of claim 30, wherein the card magazine is used by the rewritable card printer to store unused rewritable cards, the rewritable card printer further comprising:
means for determining a location of the cleaning card within the card magazine; and
means for shuffling cards between the card magazine and a second card magazine in order to issue the cleaning card from the card magazine.

37. A rewritable card printer, comprising:
means for scanning a received rewritable card to determine the optical density of the indicia on the card; and
means for removing the rewritable card from service if the optical density indicates the card is no longer usable.

38. The rewritable card printer of claim 37, further comprising means for signaling an external host to indicate that the rewritable card is no longer usable.

39. A rewritable card printer, comprising:
means for scanning a received rewritable card to determine the optical density of the indicia on the card;
means for storing the optical density measurement; and
means for using the optical density measurement to adjust a heating process applied to the rewritable card.

40. The rewritable card printer of claim 39, wherein the heating process is used to erase the rewritable card.

41. The rewritable card printer of claim 39 wherein the heating process is used to create indicia on the rewritable card.

42. The rewritable card printer of claim 39, further comprising means for tracking the rewritable card when it is stored in a card magazine in order that the heating process may be adjusted when the card is utilized.

43. A rewritable card printer comprising means for recording on a rewritable card an amount of erase/print cycles.

44. The rewritable card printer of claim 43, wherein the amount of erase/print cycles is recorded in printed indicia.

45. The rewritable card printer of claim 43, wherein the amount of erase/print cycles is recorded in a magnetic stripe.

46. The rewritable card printer of claim 43 wherein the rewritable card is a smart card having a memory and the amount of erase/print cycles is recorded in the memory.

47. A rewritable card printer, comprising:
means for partially printing cash-out data on the rewritable card;
means for holding the rewritable card until a cash-out signal is received; and
means for printing a remainder of the cash-out data on the rewritable card.

48. A rewritable card printer, comprising:
means for sampling an optical density of the rewritable card after printing to the rewritable card; and
determining if the card image will develop a readable image based on the sampled optical density.

49. The rewritable card printer of claim 48, further comprising means for repeating the sampling periodically to re-check the optical density sample.
